(19) United States
(12) Patent Application Publication
(10) Pub. No.: US 2014/0039945 A1
(43) Pub. Date: Feb. 6, 2014

(54) Customized Check-in for Event Ticket Network Systems

(71) Applicants: Sean Robert Coady, San Francisco, CA (US); Allen Wo, San Francisco, CA (US); Thomas Ezan, San Francisco, CA (US); Dongjin Xing, Richmond, CA (US)

(72) Inventors: Sean Robert Coady, San Francisco, CA (US); Allen Wo, San Francisco, CA (US); Thomas Ezan, San Francisco, CA (US); Dongjin Xing, Richmond, CA (US)

(73) Assignee: EVENTBRITE, INC., San Francisco, CA (US)

(21) Appl. No.: 13/566,937

(22) Filed: Aug. 3, 2012

(51) Int. Cl. G06Q 10/02

(52) U.S. Cl. 705/5

(57) ABSTRACT

In one embodiment, a method includes a check-in system at an event receiving an electronic ticket from an attendee's mobile client, identifying the attendee based on the electronic ticket, accessing an associated user profile and event profile, determining customized content based on these profiles, and then transmitting the customized content to the attendee's mobile client.

### TECHNICAL FIELD

This disclosure generally relates to event management, and particularly to online event management systems.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event profiles, register for events, purchase tickets for events, and check-in at events. Online systems, such as online event management systems, can typically be accessed using suitable browser clients (e.g., MOZILLA FIREFOX, GOOGLE CHROME, MICROSOFT INTERNET EXPLORER).

### BRIEF DESCRIPTION OF THE DRAWINGS

FIG. 1 illustrates an example system for implementing an online event management system.

FIGS. 2A-2C illustrate an example of an attendee checking-in to an event.

FIG. 3 illustrates an example method for providing customized content to attendees checking-in to an event.

FIG. 4 illustrates an example computer system.

FIG. 5 illustrates an example network environment.

### DESCRIPTION OF EXAMPLE EMBODIMENTS

### System Overview

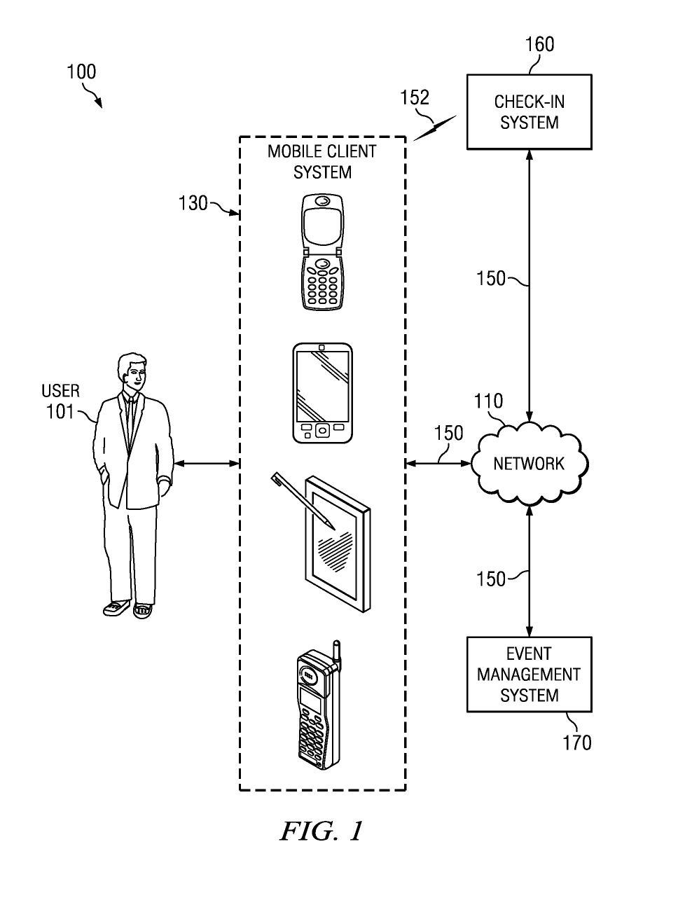

FIG. 1 illustrates an example system 100 for implementing an online event management system and a check-in system. System 100 includes a user 101, a client system 130, a check-in system 160, and an event management system 170 connected to each other by a network 110. Although FIG. 1 illustrates a particular arrangement of user 101, client system 130, check-in system 160, event management system 170, and network 110, this disclosure contemplates any suitable arrangement of user 101, client system 130, check-in system 160, event management system 170, and network 110. As an example and not by way of limitation, two or more of client system 130, check-in system 160, and event management system 170 may be connected to each other directly, bypassing network 110. As another example and not by way of limitation, two or more of client system 130, check-in system 160, and event management system 170 may be physically or logically co-located with each other in whole or in part. As yet another example, one or more check-in systems 160 may be physically or logically co-located with one or more event management systems 170 in whole or in part. Moreover, although FIG. 1 illustrates a particular number of users 101, client system 130, check-in systems 160, event management systems 170, and networks 110, this disclosure contemplates any suitable number of users 101, client systems 130, check-in systems 160, event management systems 170, and networks 110. As an example and not by way of limitation, system 100 may include multiple users 101, client systems 130, check-in systems 160, event management systems 170, and networks 110.

In particular embodiments, an event management system 170 may be a network-addressable computing system that can host one or more event organization and management systems. An event management system 170 may generate, store, receive, and transmit event-related data, such as, for example, event profiles, event details, event history details, event registration details, event organizer details, event attendee details, ticket purchase details, and event displays. An event management system 170 may be accessed by the other components of system 100 either directly or via network 110. In particular embodiments, check-in system 160 may be a network-addressable computing system that can host one or more pricing engines or modules. Check-in system 160 may generate, store, receive, and transmit check-in information, such as, for example, ticket information, attendee information, event-related data, event organizer information, purchase information, and other data relevant to checking-in attendees to an event. Check-in system 160 may be accessed by the other components of system 100 either directly or via network 110. Check-in system 160 may be an independent system or a subsystem of event management system 170.

In particular embodiments, one or more users 101 may use one or more client systems 130 to access, send data to, and receive data from an event management system 170. A client system 130 may access an event management system 170 directly, via network 110, or via a third-party system. A client system 130 may be any suitable computing device, such as, for example, a personal computer, a laptop, a cellular phone, a smart phone, or a computing tablet. In particular embodiments, one or more users 101 may be an automated system, such as, for example, a computer program, an internet bot, another type of automated system, or two or more such systems.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, check-in system 160, and event management system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular telephone network, another link 150, or a combination of two or more such links 150. Links 150 need not necessarily be the same throughout system 100. One or more first links 150 may differ in one or more respects from one or more second links 150.

### Event Management Systems

In particular embodiments, an event management system 170 may allow users to create, organize and manage events. An event may be, for example, a party, a concert, a conference, a sporting event, a fundraiser, a networking event, or a live performance. Events may occur online (such as, for example, a web-based seminar) and offline (such as, for example, a live seminar in a lecture hall). An online event management system may allow an event organizer to organize and manage various aspects of an event, such as, for example, creating event profiles, managing attendee registrations and selling tickets, managing funds from ticket sales, promoting the event, and managing attendee check-in at the event. An online event management system may also allow event attendees to view and manage various aspects of registering for an event, such as, for example, viewing event profiles, viewing event history information, registering for events, and purchasing tickets for events. As an example and not by way of limitation, a first user may use event management system 170 to create and organize an event. The first user may create an event profile for the event and input event information or event parameters associated with the event. As used herein, the terms “event information” and “event parameter” may be used interchangeably to refer to data in an event profile describing one or more aspects of or related to an event. The event profile may be viewable in one or more webpages or other content served by event management system 170. One or more second users may then use event management system 170 to register for the event. The second users may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event management system 170 may have an event profile associated with each event managed by the system. An event profile may be accessed and displayed by any suitable client system 130. An event profile may include event information describing the event title, the event date/time, the event category or type, the event details, the description of the event, the event cost or ticket price for the event, the event organizer, the event promoter, the geographic location of the event, the venue for the event, a venue capacity, the performer for the event, the number of tickets available for the event, the type/class of tickets available for the event, the ticket identifiers, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, and the like), privacy settings for the event profile, or other suitable event information. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, IP address, device identifier, purchase information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR code, or another suitable unique identifier. A ticket identifier may also be information describing the attendee, such as the attendee's name, email address, credit card number, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, the event profile may include purchase information for the event. A purchase information may include, for example, a user 101's name, phone number, mailing address, email address, billing address, payment information, ticket order information, credit card information, bank account number, PAYPAL username, cash payment information, money transfer information, address verification system score for the payment, validity information for the payment, or other suitable purchase information. Although this disclosure describes particular types of purchase information, this disclosure contemplates any suitable types of purchase information.

In particular embodiments, the event management system 170 may maintain user profile for each user 101. The user profile may contain a variety of information about the user 101. As an example and not by way of limitation, a user profile may contain personal information (such as, for example, name, sex, location, income, interests), social-network information (such as, for example, friend connections, personal information about user 101's friends), financial information (such as, for example, income, credit history), event-history information (such as, for example, the type, data, cost, venue, performers, geographic location of the events a user 101 has organized, registered for, or attended), or other suitable information related to the user 101. Although this disclosure describes user profiles containing particular types of information about a user 101, this disclosure contemplates user profile containing any suitable information about a user 101.

In particular embodiments, a user profile may also include event history information associated with the user 101. The event history information may include event information and purchase information associated with one or more events the user 101 has attended or has registered to attend, as well as purchase-history information associated with each event. The event history information may also include event information associated with one or more event profiles a user 101 has created, organized, and managed. Although this disclosure describes particular event history information, this disclosure contemplates any suitable event history information.

In particular embodiments, the event management system 170 may use a unique client identifier (ID) to identify a user 101. As an example and not by way of limitation, the event management system 170 may assign a unique device ID to each client system 130. The event management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event management system 170 may assign a unique user ID to each user 101, which the user may provide to the event management system 170 via a client system 130. The event management system 170 may assign each user 101 with a username and password that the user 101 can input into client system 130, which then transmits the username and password to the event management system 170. In particular embodiments, the event management system 170 can use the unique client identifier (such as, for example, a device ID or user ID) to determine that the user 101 is accessing the system. As yet another example and not by way of limitation, the event management system 170 may assign a unique client identifier to each attendee of an event. Although this disclosure describes particular types of unique client identifiers, this disclosure contemplates any suitable types of unique client identifiers. Moreover, although this disclosure describes using client identifiers in a particular manner, this disclosure contemplates using client identifiers in any suitable manner.

In particular embodiments, an event management system 170 may use a “shopping cart” model to facilitate event registration. As an example and not by way of limitation, event management system 170 may present a user 101 with a plurality of event profiles. The user 101 may select one or more of the events to register for. When the user 101 selects an event profile on event management system 170, the event management system 170 may metaphorically add that item (e.g., registration for the event) to a shopping cart. If appropriate, the user 101 may also select a ticket type or a number of tickets for the event. When the user 101 is done selecting event profiles, then all the items in the shopping cart may be “checked out” (i.e., ordered) when the user 101 provides purchase information (and possibly shipment information). In some embodiments, when a user 101 selects an event profile, then that event profile may be “checked out” by automatically prompting the user for purchase information, such as, for example, the user's name and purchase information. The user 101 then may be presented with a registration webpage that prompts the user for the user-specific registration information to complete the registration. That webpage may be pre-filled with information that was provided by the user 101 when registering for another event or when establishing a user profile on the event management system 170. The information may then be validated by the event management system 170, and the registration may be completed. At this point, the user 101 may be presented with a registration confirmation webpage or a receipt that displays the details of the event and registration details. Event management system 170 may also charge or withdraw funds from a financial account associated with user 101 based on the purchase information provided by the user 101. The “shopping cart” model may be facilitated by a client system 130 operating offline from event management system 170. In particular embodiments, after a user 101 purchases a ticket for an event, the event management system 170 may transmit or otherwise make available an electronic ticket for the event, which may be accessed by the user 101 on a suitable client system, such as, for example, a mobile client system 130. Each electronic ticket may include a unique ticket identifier that may be used to identify the electronic ticket and/or the attendee/user 101. Although this disclosure describes particular means for registering for events and purchasing tickets, this disclosure contemplates any suitable means for registering for events and purchasing tickets.

### Event Check-in Systems

In particular embodiments, a check-in system 160 may be used at an event to check-in one or more attendees/users to the event. The event attendee list may indicate the check-in status for each attendee registered for the event. Check-in status may indicate whether an attendee is or is not checked-in at the event (i.e., whether the attendee has arrived at the event). In particular embodiments, the check-in system 160 may receive an indication that the attendee has arrived at an event. As an example and not by way of limitation, the event organizer may use a check-in system 160 to access an event attendee list and select an attendee from the list to indicate that an attendee had arrived. As another example and not by way of limitation, an attendee may use the check-in system 160 to access the event attendee list and select himself from the list to indicate that he has arrived (i.e., self-check in). In particular embodiments, the check-in system 160 may search the event attendee list for the name, email address, or ticket identifier of the attendee and then select the attendee from the event attendee list. As an example and not by way of limitation an attendee may access an event attendee list on the check-in system 160. The attendee may input one or more search criteria into the check-in system 160. The check-in system 160 may then search the event attendee list and identify one or more attendees that match the search criteria. The attendee may then select one or more attendees from the search results provide by the check-in system 160 to indicate that those attendees have arrived. As another example and not by way of limitation, an attendee may provide a unique identifier (e.g., name, email, ticket identifier) to the check-in system 160, and the system may search the event attendee list, verify the attendee is on the list, and then indicate the attendee is checked-in. In particular embodiments, the check-in system 160 may scan a ticket for a ticket identifier and identify the attendee based on the ticket identifier. The ticket identifier may be a barcode, a 2D barcode, a QR code, or another suitable scannable identifier. A ticket identifier may be scanned using any suitable scanning device, such as, for example a camera, an optical scanner, a barcode scanner, a QR code scanner, or another suitable scanning device. As an example and not by way of limitation, the check-in system 160 may receive one or more ticket identifiers from one or more tickets (such as, for example, by scanning the tickets with a scanner). The check-in system 160 may then automatically provide an indication that the attendee associated with the scanned ticket identifier has arrived. In particular embodiments, the check-in system 160 may receive the name, email address, or ticket identifier of the attendee from a mobile client system 130 associated with the attendee and then identify the attendee based on the received name, email address, or ticket identifier. As an example and not by way of limitation, an attendee may transmit a message or signal (such as, for example, an email, text message, radio frequency identification tag, another suitable message or signal, or any combination thereof) to a check-in system 160 containing the attendee's name, email address, or ticket identifier. The check-in system 160 may then automatically provide an indication that the attendee associated with the name, email address, or ticket identifier has arrived. In particular embodiments, the check-in system 160 may update the check-in status of the attendee to indicate that the attendee is checked-in. As an example and not by way of limitation, after receiving an indication that an attendee has arrived at an event, a check-in system 160 may access an event attendee list and change the check-in status of the attendee from not checked-in to checked-in. Although this disclosure describes checking-in attendees in a particular manner, this disclosure contemplates checking-in attendees in any suitable manner. Moreover, although this disclosure describes checking-in attendees using particular components of system 100, this disclosure contemplates checking-in attendees using any suitable components of system 100. Systems and methods for checking-in attendees to an event are further described in U.S. patent application Ser. No. 13/234000, filed 15 Sep. 2011, titled “System for On-site Management of an Event,” which is incorporated herein by reference. Furthermore, although this disclosure describes particular methods for checking-in attendees to an event, this disclosure contemplates using these methods or analogous methods for checking-out attendees from an event. As an example and not by way of limitation, the check-in system 160 may receive an indication that an attendee is checking-out from an event. When the attendee exits the event venue or otherwise leaves that event, the attendee may have his ticket scanned upon exit, or may used the check-in system 160 to provide an indication that he is leaving the event.

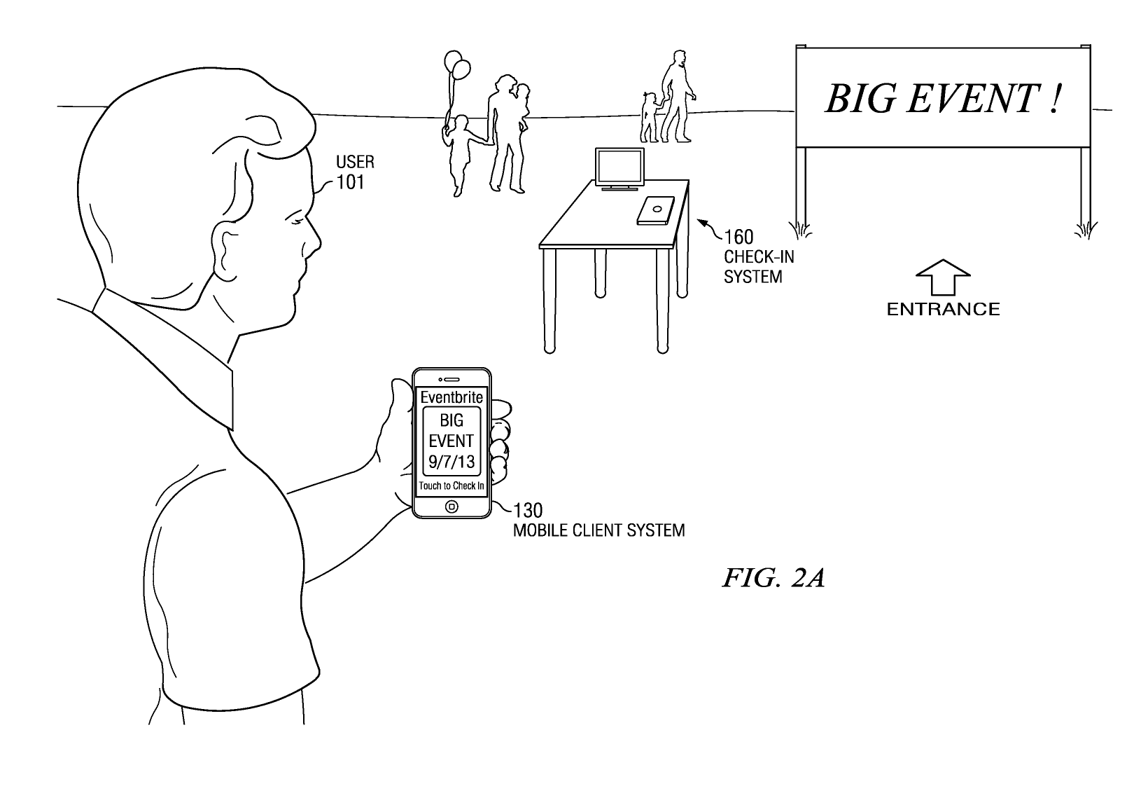

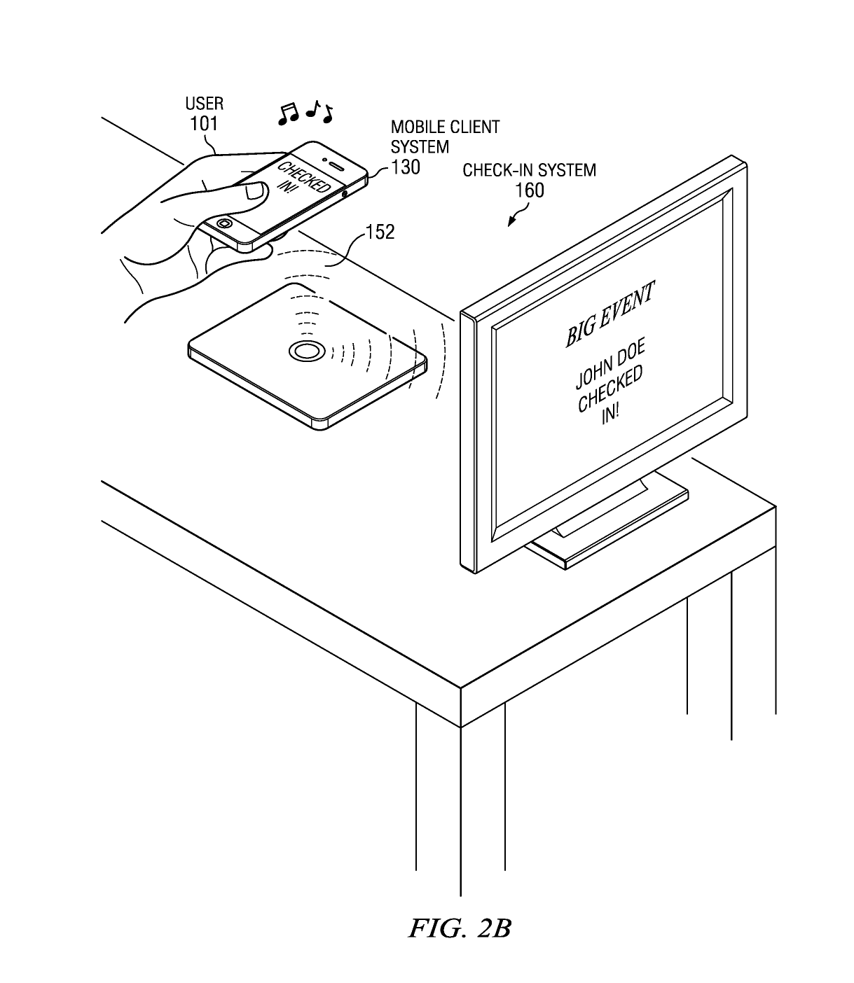

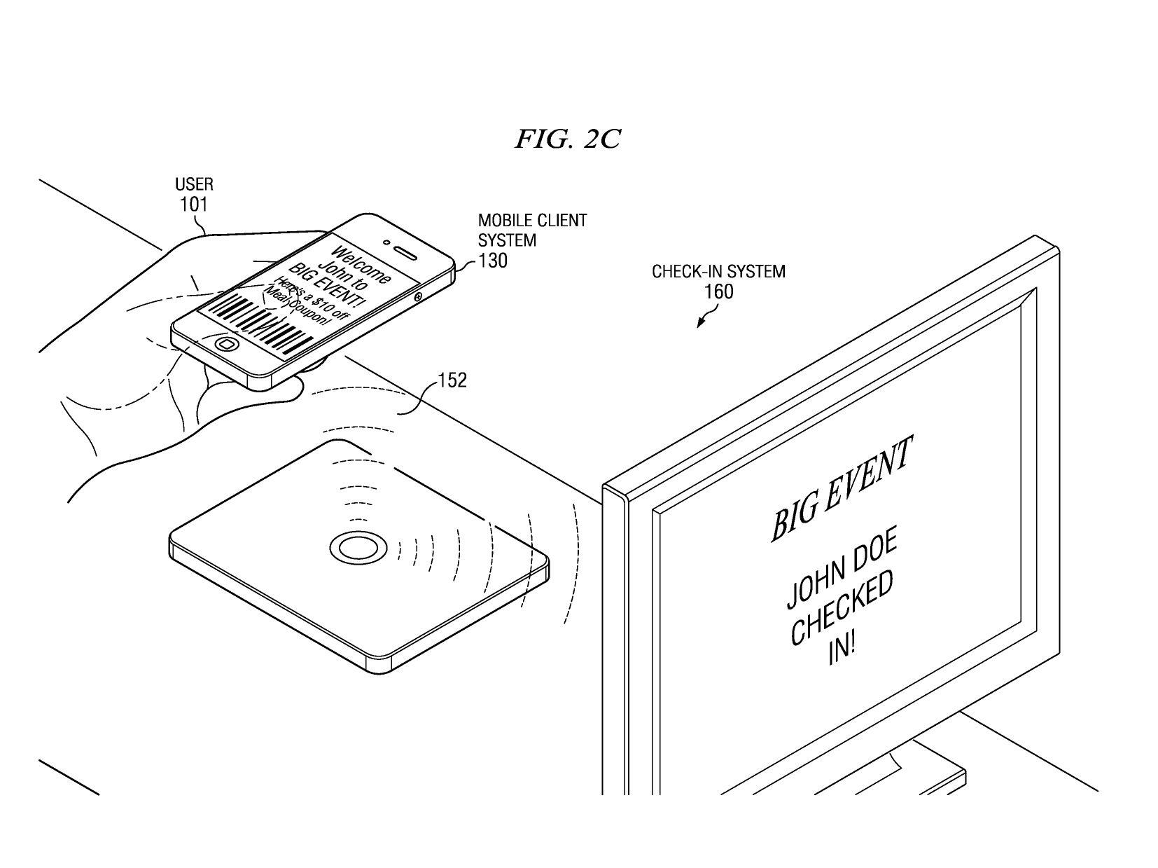

FIGS. 2A-2C illustrate an example of an attendee/user 101 checking-in to an event. In particular embodiments, an attendee may check-in to an event using a mobile client device 130 and a check-in system 160 with a wireless access terminal. A mobile client device 130 may be able to access and/or store an electronic ticket that can be transmitted to the wireless access terminal of the check-in system 160 via a wireless link 152. The check-in system 160 may then verify whether the electronic ticket is valid and, if so, update the check-in status of the attendee to indicate that the attendee is checked-in. The check-in system 160 may then transmits customized content to the mobile client system 130 in response to the attendee checking in. These processes are described in more detail below. Although this disclosure describes and FIGS. 2A-2C illustrate particular attendees checking-in to a particular event in a particular manner, this disclosure contemplates any suitable attendees checking into any suitable event in any suitable manner.

FIG. 2A illustrates an example entrance to an event. The event entrance may be used to control egress for an event. The event entrance may include a check-in system 160 that is capable of communicating with a mobile client system 130 via a wireless access terminal. As an example and not by way of limitation, FIG. 2A illustrates a mobile client system 130 displaying an electronic ticket for “BIG EVENT.” The electronic ticket instructs the user 101 to “Touch to Check In,” which indicates that the user 101 may check-in to the event by touching or otherwise placing the mobile client system 130 in proximity with the wireless access terminal of the check-in system 160. The wireless access terminal may be, for example, a near-field communication (NFC) system, a radio-frequency identification (RFID) system, another suitable system, or any combination thereof. In particular embodiments, the wireless access terminal may include a near-field communication (NFC) interface. The NFC interface may allow for close-range communication, and may comply with various standards, such as, for example, ISO/IEC 18092, ECMA-340, ISO/IEC 21481, ECMA-352, ISO 14443, ISO 15693, other suitable standards, or any combination thereof. The NFC interface may have a range of approximately 2-4 cm, although other ranges are possible. The close-range communication with the NFC interface may take place via magnetic-field induction, allowing the NFC interface to communicate with other NFC interfaces or to retrieve information from tags having radio-frequency identification (RFID) circuitry. In particular embodiments, the NFC interface may permit near field communication between the check-in system 160 and other NFC-enabled electronic devices, such as, for example, a mobile client system 130. As an example and not by way of limitation, the NFC interface included with the check-in system 160 may enable data transfer between the check-in system 160 and the mobile client system 130. Although this disclosure describes and FIG. 2A illustrates a particular entrance to an event, this disclosure contemplates any suitable entrance to an event.

FIG. 2B illustrates an example of a user 101 using a mobile client system 130 to check-in to an event. In particular embodiments, check-in system 160 may receive information associated with an electronic ticket for an event from a mobile client system 130. A user 101 may have a mobile client system 130 capable of accessing and/or storing an electronic ticket for the event. As an example and not by way of limitation, FIG. 2B illustrates a user 101 checking in to an event using the electronic ticket on the mobile client system 130. An attendee may approach the check-in system 160 at the entrance to the event and then may touch or otherwise place the mobile client system 130 in proximity with a wireless access terminal of the check-in system 160. The check-in system 160 may then receive information associated with an electronic ticket for the event from the mobile client system 130. As an example and not by way of limitation, the mobile client system 130 may transmit a ticket identifier to the check-in system 160. In particular embodiments, the information associated with the electronic ticket may be received by the check-in system 160 via a wireless access terminal. The mobile client system 130 may connect to a check-in system 160 via one or more wireless links 152. The information may be transmitted while the mobile client system 130 is in close proximity with the wireless access terminal. As an example and not by way of limitation, the check-in system 160 illustrated in FIG. 2B includes a wireless access terminal that can connect to the mobile client device 130 by a wireless link 152. The mobile client device 130 may include a system capable of transmitting data to and receiving data from a wireless access terminal of a check-in system 160 via a wireless link 152, such as an NFC interface or another suitable system. The NFC interface may enable the mobile client system 130 to communicate with RFID tags and/or other NFC-enabled electronic devices. As an example and not by way of limitation, the NFC interface may enable transmission of information associated with an electronic ticket for an event from a mobile client system 130 to a check-in system 160 via the wireless access terminal. If the mobile client system 130 is within range of an NFC interface on a check-in system 160, the check-in system 160 may receive an NFC transmission from the mobile client system 130 and initiate checking-in the user 101 to the event. In particular embodiments, the information associated with the electronic ticket transmitted by the mobile client system 130 may include a ticket identifier. The check-in system 160 may use a ticket identifier included with the electronic ticket to look up the attendee in an event attendee list to determine whether the electronic ticket is valid. If the electronic ticket is valid, the check-in system 160 may update an event attendee list to indicate that the attendee has checked in. The check-in system 160 may also transmit information to the mobile client device 130 indicating that the user has been checked in. In response, the mobile client device 130 may display a message indicating that the attendee is checked in, such as displaying “Checked In!”, as illustrated in FIG. 2B. In particular embodiments, the check-in system 160 may also include an interface for an event organizer or security official to access an attendee list, monitor attendees as then enter and/or leave the event, and sell tickets for the event to attendees. As an example and not by way of limitation, the check-in system 160 illustrated in FIG. 2B includes a monitor indicating “John Doe Checked In!”, which displays after the particular attendee illustrated has checked in with mobile client device 130. Although this disclosure describes and FIG. 2B illustrates a particular user checking-in to a particular event in a particular manner, this disclosure contemplates any suitable user checking-in to any suitable event in any suitable manner.

### Customized Check-in

FIG. 2C illustrates an example of a mobile client device 130 receiving and displaying customized content from a check-in system 160. In particular embodiments, after an attendee/user has checked in to an event using a mobile client system 130 with an electronic ticket, the check-in system 160 may transmit customized content to the mobile client device via a wireless access terminal. The check-in system 160 may transmit advertisements, coupons, event information, other suitable customized content, or any combination thereof to the mobile client system 130. The customized content may then be stored and/or displayed on the mobile client device 130 so that it may be viewed by the attendee. As an example and not by way of limitation, the example illustrated in FIG. 2C shows the mobile client system 130 displaying a customized coupon “Welcome John to BIG EVENT! Here's a $10 off Meal Coupon!” Although this disclosure describes and FIG. 2C illustrates receiving and displaying particular customized content in a particular manner, this disclosure contemplates receiving and displaying any suitable customized content in any suitable manner. Furthermore, although this disclosure describes and FIG. 2C illustrates particular methods for receiving and displaying customized content when an attendee checks-in to an event, this disclosure contemplates using these methods or analogous methods for receiving and displaying customized content when an attendee checks-out from an event. As an example and not by way of limitation, the check-in system 160 may transmit advertisements, coupons, event information, other suitable customized content, or any combination thereof to the mobile client system 130 of an attendee when the attendee is exiting or otherwise leaving an event.

In particular embodiments, check-in system 160 may identify a user 101 based on the ticket identifier. Each electronic ticket may have a unique ticket identifier, and this ticket identifier (and thus the electronic ticket) may be associated with a particular attendee/user 101, such as, for example, the user 101 that purchased the ticket on the event management system 170. As an example and not by way of limitation, the check-in system 160 may access an event attendee list and search for the ticket identifier received by the check-in system 160. The event attendee list may identify one or more attendees/users 101 and/or user profiles associated with the ticket identifier. Although this disclosure describes receiving information associated with an electronic ticket in a particular manner, this disclosure contemplates receiving information associated with an electronic ticket in any suitable manner.

In particular embodiments, check-in system 160 may access a user profile associated with the user 101 and an event profile associated with the event. As an example and not by way of limitation, when the attendee/user “John Doe” checks in to the event “Big Event,” as illustrated in FIG. 2B, the check-in system 160 may access the user profile associated with the user “John Doe” and the event profile associated with the event “Big Event.” The user profile associated with a user 101 may contain a variety of information about the user 101, such as, for example, personal information, social-network information, financial information, event history information, purchase-history information, or other suitable information related to the user 101. The event profile associated with the event may contain a variety of information about the event, such as, for example, event details, event attendee lists, ticket information, purchase information, purchase offers, or other suitable information related to the event. Although this disclosure describes accessing particular user profiles and particular event profiles in a particular manner, this disclosure contemplates accessing any suitable user profiles and any suitable event profiles in any suitable manner.

In particular embodiments, check-in system 160 may determine customized content based on the user profile and the event profile. The check-in system 160 may retrieve or generate personalized advertisements, coupons, event information, or other content that is customized for the user 101 that is checking in. The customized content may be customized based on the user profile associated with the user 101 and the event profile associated with the event. The check-in system 160, possibly in conjunction with event management system 170, may be able to determine relevant customized content to present to a user 101 based on the past behavior of the user 101 and/or other user profile information. This user information may be matched to particular event information to determine the most relevant customized content to present to the user 101. In particular embodiments, the customized content may be related to the event the user 101 is checking-in to. As an example and not by way of limitation, the customized content displayed on the mobile client device 130 illustrated in FIG. 2C is customized for the attendee “John Doe” based on his user profile, which may indicate his name and that he has purchased food at prior events, and further based on the event profile for the event, which may indicate that various meal coupons are available for distribution to attendees. In particular embodiments, the customized content may be related to other events. As an example and not by way of limitation, when the attendee “John Doe” checks in to the event “Big Event,” the check-in system 160 may generate an advertisement for a second event that the system has determined the attendee might be interested in based on the attendee's user profile (which may indicate the previous types of events the attendee has attended, and thus may indicate an interest in events like the second event) and the event profile for “Big Event” (which may indicate the type and cost of the event, and thus may indicate other events that attendees of the “Big Event” might be interested in). Although this disclosure describes determining particular customized content in a particular manner, this disclosure contemplates determining any suitable customized content in any suitable manner.

The customized content may comprise various types of content. In particular embodiments, the customized content may be an advertisement or coupon. The advertisement or coupon may be related to the event the user is checking-in to or to another event. As an example and not by way of limitation, when an attendee checks-in to an event, the check-in system 160 may generate an advertisement or coupon for goods or services at the event. As another example and not by way of limitation, when an attendee checks-in to a concert by the singer Bjork, the check-in system 160 may generate an advertisement or coupon for an upcoming concert by the band Portishead, where the system has determined that the attendee may be interested in this upcoming concert based on his interest in Bjork and Bjork's musical similarities to Portishead. In particular embodiments, the customized content may be event information. The event information may be related to the event the attendee is checking-in to. As an example and not by way of limitation, when a user 101 check-in to an event, the check-in system 160 may generate directions from the event entrance to the attendee's seat at the event and transmit those directions to the mobile client system of the user 101. As another example and not by way of limitation, when a first attendee checks-in to an event, the check-in system 160 may determine that friends of the first attendee have already checked-in to the event based on social-network information contained in the first attendee's user profile. The check-in system 160 may then transmit that information to the mobile client system 130 of the first attendee, along with directions to where the first attendee's friends are seated at the event. Although this disclosure describes determining customized content in a particular manner, this disclosure contemplates determining customized content in any suitable manner.

In particular embodiments, check-in system 160 may determine customized content based on purchase-history information associated with the user profile of the user 101. As an example and not by way of limitation, the check-in system 160 may access purchase-history information associated with the user profile of the user. The purchase-history information may describe past purchases made by the user 101, such as, for example, past tickets purchased for events, goods and services purchased at those events, transportation and lodging associated with those events, or other suitable purchase information. This purchase-history information may be used to predict the interests of the user 101 and predict purchases the user 101 may be likely to make at current and future events. The check-in system 160 may then access one or more purchase offers associated with the event profile of the event. For example, a particular event may have particular purchase offers available to offer to attendees based on the good and services available at the event. If cocktails are available at the event, there may be coupons available for discounts on cocktails, or advertisements to pre-purchase cocktails for intermission (which could be purchased, for example, via the mobile client system 130 and then held under the user 101's name). If seat upgrades are available at the event, there may be advertisements available for immediate seat upgrades (which could similarly be purchased with the mobile client system 130, which could then provide directions to the user 101's new seat). The check-in system 160 may then identify one or more of the purchase offers that correspond to the purchase-history information associated with the user. For example, a particular attendee/user 101 may have a history of taking advantage of various purchase offers, or of buying particular goods or services at prior events. If the user 101 has a history of buying alcoholic beverages at prior events, the check-in system 160 may identify coupons for discounted cocktails from the available purchase offers as being appropriate customized content to provide to the user 101. The check-in system 160 may then retrieve customized content based on one or more of the identified purchase offers. For example, particular purchase offers may have pre-generated content (such as, for example, text, images, etc.) associated with the purchase offer that may be used as the customized content to transmit to the user 101. If the check-in system 160 has identified a coupon for discounted cocktails, the system may access a data store containing the content comprising the coupon (e.g., text reading “Here's a coupon for $5 off your next Manhattan. Buy one at the bar on the mezzanine level at intermission!”, and a digital image of the cocktail along with a map to the bar) and format that coupon for transmittal and display. Alternatively, the check-in system may generate customized content based on the purchase-history information and the identified purchase offers. For example, content may need to be generated for particular purchase offers if no pre-generated content is available. The check-in system 160 may generate content (e.g., text, images, etc.) as appropriate and format that content into customized content for transmittal and display. Although this disclosure describes determining customized content based on purchase-history information in a particular manner, this disclosure contemplates determining customized content based on purchase-history information in any suitable manner.

In particular embodiments, check-in system 160 may determine customized content based on information related to the user received from the mobile client system 130. After a user 101 checks in to an event, the mobile client system 130 may access information related to the user 101 that is stored on the mobile client system 130 and transmit that information to the check-in system 160. The mobile client system 130 may store a variety of information related to the user, such as, for example, the user's personal information, phone number, current and prior geographic locations, or other suitable information related to the user. As an example and not by way of limitation, after a user 101 checks-in to an event, the mobile client system 130 may transmit information related to prior events the mobile client system 130 was used for checking-in to, such as, for example, event-history information describing these events and purchase-history information describing the user 101's purchases at these events. Based on this information related to prior events, the check-in system 160 may generate customized content, such as advertisements and coupons, related to the current event. For example, if the mobile client system 130 tells the check-in system 160 that the user 101 had upgraded his tickets from “General Seating” to “VIP Seating” after arriving at the most recent prior event, the check-in system 160 may generate a customized advertisement for the user 101 offering “Upgrade your seat right now for only $30! Click here to buy!” Although this disclosure describes determining particular customized content in a particular manner, this disclosure contemplates determining any suitable customized content in any suitable manner.

In particular embodiments, check-in system 160 may transmit customized content to the mobile client system 130 via a wireless access terminal. The mobile client system 130 may connect to the check-in system 160 via a wireless link 152 to the wireless access terminal of the check-in system 160. The transmitted customized content may then be stored on the mobile client system 130 and/or may be displayed on the mobile client system to the attendee/user 101. As an example and not by way of limitation, the example illustrated in FIG. 2C shows that, after the user 101 has checked-in to the “Big Event,” the check-in system 160 has transmitted the customized coupon “Welcome John to BIG EVENT! Here's a $10 off Meal Coupon!” to the mobile client system 130, and the coupon is being displayed on the mobile client system 130. Although this disclosure describes transmitting particular customized content in a particular manner, this disclosure contemplates transmitting any suitable customized content in any suitable manner.

In particular embodiments, check-in system 160 may verify the identity of the attendee based on information received from the mobile client system 130. As an example and not by way of limitation, when checking in to an event using a mobile client system 130, in addition to transmitting information associated with an electronic ticket, the mobile client system 130 may also transmit other identifying information associated with the attendee, such as, for example, the attendee's name or email address. The check-in system 160 may then verify the identity of the attendee based on the received name or email address. For example, the check-in system 160 may access an event attendee list to look up the name or email address in an event attendee list to determine whether the name or email address transmitted with the electronic ticket information is valid. If the name or email address is valid, then the check-in system 160 may updated the check-in status of the attendee to indicate that the attendee is checked-in. Although this disclosure describes verifying the identity of an attendee in a particular manner, this disclosure contemplates verifying the identity of an attendee in any suitable manner.

In particular embodiments, check-in system 160 may be used to purchase an electronic ticket for an event. As an example and not by way of limitation, a user 101 may purchase or otherwise obtain an electronic ticket for an event from the check-in system 160 using a mobile client system 130. The mobile client system 130 may transmit purchase information to the check-in system 160 (for example, via a wireless access terminal). The check-in system 160 may then transmit the information to the event management system 170 for processing. Alternatively, the check-in system 160 may process the purchase transaction independently of event management system 170. Once the purchase information is verified, the check-in system 160 may transmit an electronic ticket for the event to the mobile client system 130. The user may then use the electronic ticket at the check-in system 160 to check in to the event. Although this disclosure describes purchasing an electronic ticket for an event in a particular manner, this disclosure contemplates purchasing an electronic ticket for an event in any suitable manner.

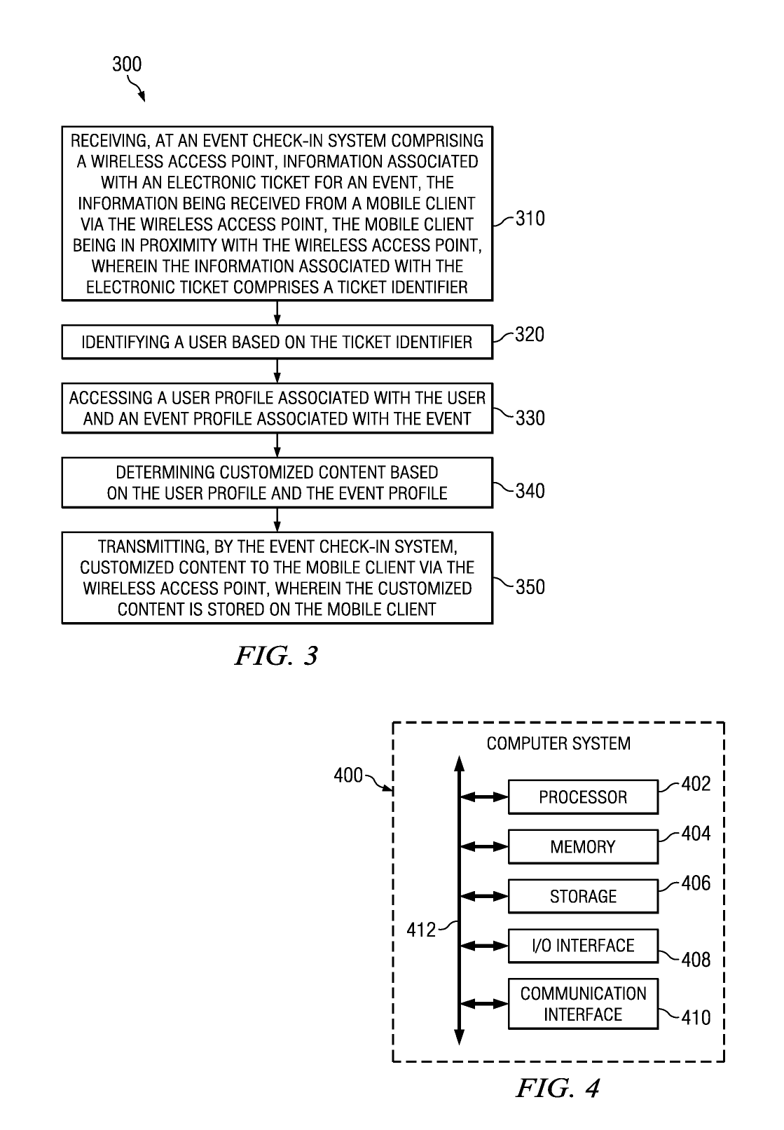

FIG. 3 illustrates an example method 300 for providing customized content to attendees checking-in to an event. The method may begin at step 310, where the check-in system 160 receives information associated with an electronic ticket for an event, wherein the electronic ticket includes a ticket identifier. The information may be received by the check-in system 160 at a wireless access terminal from a mobile client that is in proximity with the wireless access terminal. At step 320, the check-in system 160 may identify a user 101 based on the ticket identifier. At step 330, the check-in system 160 may access a user profile associated with the user 101 and an event profile associated with the event. At step 340, the check-in system 160 may determine customized content based on the user profile and the event profile. At step 350, the check-in system 160 may transmit customized content to the mobile client via the wireless access terminal, wherein the customized content is stored on the mobile client. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

### Systems and Methods

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable non-transitory storage medium may include a semiconductor-based or other integrated circuit (IC) (such as, for example, a field-programmable gate array (FPGA) or an application-specific IC (ASIC)), a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, another suitable computer-readable non-transitory storage medium, or a suitable combination of these, where appropriate. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 402 (such as, for example, one or more internal registers or caches), one or more portions of memory 404, one or more portions of storage 406, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

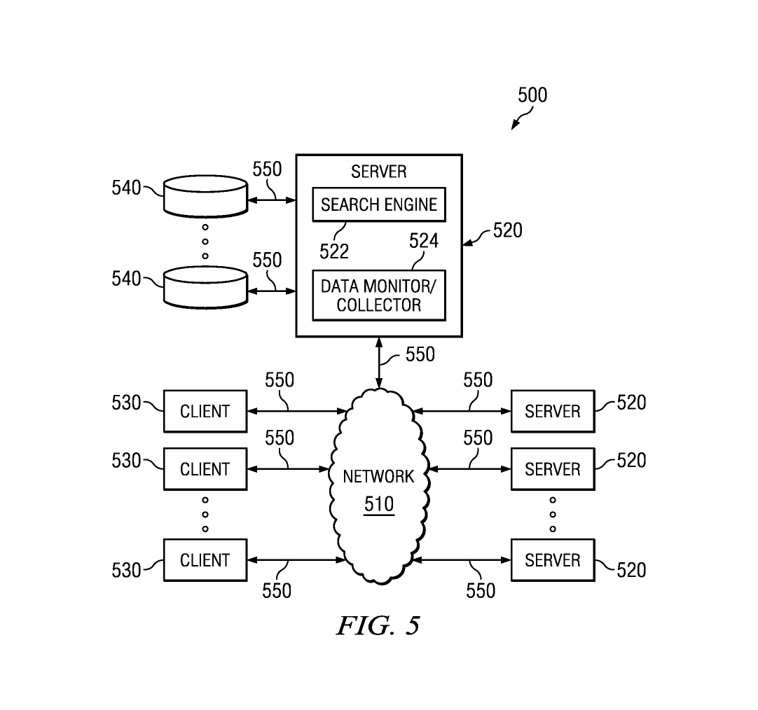

FIG. 5 illustrates an example network environment 500. This disclosure contemplates any suitable network environment 500. As an example and not by way of limitation, although this disclosure describes and illustrates a network environment 500 that implements a client-server model, this disclosure contemplates one or more portions of a network environment 500 being peer-to-peer, where appropriate. Particular embodiments may operate in whole or in part in one or more network environments 500. In particular embodiments, one or more elements of network environment 500 provide functionality described or illustrated herein. Particular embodiments include one or more portions of network environment 500. Network environment 500 includes a network 510 coupling one or more servers 520 and one or more clients 530 to each other. This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 couple servers 520 and clients 530 to network 510 or to each other. This disclosure contemplates any suitable links 550. As an example and not by way of limitation, one or more links 550 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 550. In particular embodiments, one or more links 550 each includes an intranet, an extranet, a VPN, a LAN, a WLAN, a WAN, a MAN, a communications network, a satellite network, a portion of the Internet, or another link 550 or a combination of two or more such links 550. Links 550 need not necessarily be the same throughout network environment 500. One or more first links 550 may differ in one or more respects from one or more second links 550.

This disclosure contemplates any suitable servers 520. As an example and not by way of limitation, one or more servers 520 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 520 includes hardware, software, or both for providing the functionality of server 520. As an example and not by way of limitation, a server 520 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 530, the web server may communicate one or more such files to client 530. As another example, a server 520 that operates as a mail server may be capable of providing e-mail services to one or more clients 530. As another example, a server 520 that operates as a database server may be capable of providing an interface for interacting with one or more data stores (such as, for example, data stores 540 described below). Where appropriate, a server 520 may include one or more servers 520; be unitary or distributed; span multiple locations; span multiple machines; span multiple datacenters; or reside in a cloud, which may include one or more cloud components in one or more networks.

In particular embodiments, one or more links 550 may couple a server 520 to one or more data stores 540. A data store 540 may store any suitable information, and the contents of a data store 540 may be organized in any suitable manner. As an example and not by way or limitation, the contents of a data store 540 may be stored as a dimensional, flat, hierarchical, network, object-oriented, relational, XML, or other suitable database or a combination or two or more of these. A data store 540 (or a server 520 coupled to it) may include a database-management system or other hardware or software for managing the contents of data store 540. The database-management system may perform read and write operations, delete or erase data, perform data deduplication, query or search the contents of data store 540, or provide other access to data store 540.

In particular embodiments, one or more servers 520 may each include one or more search engines 522. A search engine 522 may include hardware, software, or both for providing the functionality of search engine 522. As an example and not by way of limitation, a search engine 522 may implement one or more search algorithms to identify network resources in response to search queries received at search engine 522, one or more ranking algorithms to rank identified network resources, or one or more summarization algorithms to summarize identified network resources. In particular embodiments, a ranking algorithm implemented by a search engine 522 may use a machine-learned ranking formula, which the ranking algorithm may obtain automatically from a set of training data constructed from pairs of search queries and selected Uniform Resource Locators (URLs), where appropriate.

In particular embodiments, one or more servers 520 may each include one or more data monitors/collectors 524. A data monitor/collection 524 may include hardware, software, or both for providing the functionality of data collector/collector 524. As an example and not by way of limitation, a data monitor/collector 524 at a server 520 may monitor and collect network-traffic data at server 520 and store the network-traffic data in one or more data stores 540. In particular embodiments, server 520 or another device may extract pairs of search queries and selected URLs from the network-traffic data, where appropriate.

This disclosure contemplates any suitable clients 530. A client 530 may enable a user at client 530 to access or otherwise communicate with network 510, servers 520, or other clients 530. As an example and not by way of limitation, a client 530 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 530 may be an electronic device including hardware, software, or both for providing the functionality of client 530. As an example and not by way of limitation, a client 530 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 530 may include one or more clients 530; be unitary or distributed; span multiple locations; span multiple machines; span multiple datacenters; or reside in a cloud, which may include one or more cloud components in one or more networks.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more processors associated with one or more computing devices:
receiving, at an event check-in system comprising a wireless access terminal, information associated with an electronic ticket for an event, the information being received from a mobile client via the wireless access terminal, the mobile client being in proximity with the wireless access terminal, wherein the information associated with the electronic ticket comprises a ticket identifier;
identifying a user based on the ticket identifier;
accessing a user profile associated with the user and an event profile associated with the event;
determining customized content based on the user profile and the event profile; and
transmitting, by the event check-in system, customized content to the mobile client via the wireless access terminal, wherein the customized content is stored on the mobile client.

2. The method of claim 1, wherein the wireless access terminal is a radio-frequency identification system.

3. The method of claim 1, wherein the wireless access terminal is a near-field communication system.

4. The method of claim 1, wherein determining customized content based on the user profile and the event profile comprises:
accessing purchase-history information associated with the user profile of the user;
accessing one or more purchase offers associated with the event profile of the event:
identifying one or more of the purchase offers that correspond to the purchase-history information associated with the user; and
retrieving customized content based on one or more of the identified purchase offers.

5. The method of claim 1, wherein determining customized content based on the user profile and the event profile comprises:
accessing purchase-history information associated with the user profile of the user;
accessing one or more purchase offers associated with the event profile of the event:
generating customized content based on the purchase-history information and one or more of the identified purchase offers.

6. The method of claim 1, further comprising:
receiving information related to the user from the mobile client; and
wherein determining customized content is further based on the information related to the user received from the mobile client.

7. The method of claim 1, wherein the customized content comprises an advertisement.

8. The method of claim 1, wherein the customized content comprises a coupon.

9. The method of claim 1, wherein the customized content comprises event information.

10. The method of claim 1, wherein the electronic ticket is being used to check-in to the event.

11. The method of claim 1, wherein the electronic ticket is being used to check-out of the event.

12. The method of claim 1, further comprising:
updating a check-in status of the user to indicate that the user is checked-in.

13. The method of claim 1, further comprising:
updating a check-in status of the user to indicate that the user is checked-out.

14. The method of claim 1, further comprising:
receiving a name or email address of the user from the mobile client; and
verifying the identity of the user based on the received name or email address.

15. The method of claim 1, further comprising:
receiving payment for the electronic ticket; and
transmitting the electronic ticket for the event to the mobile client.

16. An event check-in system comprising: one or more processors; a wireless access terminal; and a memory coupled to the processors comprising instructions executable by the processors, the processors operable when executing the instructions to:
receive information associated with an electronic ticket for an event, the information being received from a mobile client via the wireless access terminal, the mobile client being in proximity with the wireless access terminal, wherein the information associated with the electronic ticket comprises a ticket identifier;
identify a user based on the ticket identifier;
access a user profile associated with the user and an event profile associated with the event;
determine customized content based on the user profile and the event profile; and
transmit customized content to the mobile client via the wireless access terminal, wherein the customized content is stored on the mobile client.

17. One or more computer-readable non-transitory storage media embodying software that is operable when executed to:
receive, at an event check-in system comprising a wireless access terminal, information associated with an electronic ticket for an event, the information being received from a mobile client via the wireless access terminal, the mobile client being in proximity with the wireless access terminal, wherein the information associated with the electronic ticket comprises a ticket identifier;
identify a user based on the ticket identifier;
access a user profile associated with the user and an event profile associated with the event;
determine customized content based on the user profile and the event profile; and
transmit, by the event check-in system, customized content to the mobile client via the wireless access terminal, wherein the customized content is stored on the mobile client.
